(19) United States
(12) Patent Application Publication
(10) Pub. No.: US 2026/0257119 A1
(43) Pub. Date: Sep. 3, 2026

(54) SYSTEM AND METHOD FOR ANALYZING GOLF SWING USING WEARABLE DEVICE

(71) Applicant: PhiNetworks Co., Ltd., Seoul (KR)

(72) Inventor: TSEVEENDORJ TSELMEG, Seoul (KR)

(21) Appl. No.: 19/531,712

(22) Filed: Feb. 6, 2026

(30) Foreign Application Priority Data
Feb. 28, 2025 (KR) 10-2025-0026878

(51) Int. Cl. A63B 69/36; A63B 24/00

(52) U.S. Cl. CPC A63B 69/3608; A63B 24/0006; A63B 2024/0012; A63B 2220/16; A63B 2220/34; A63B 2220/836; A63B 2225/50

(57) ABSTRACT

Disclosed are a system and method for analyzing a golf swing using a wearable device. More particularly, disclosed is a system for analyzing a golf swing which provides a high-efficiency operation recognition algorithm and technical solution capable of analyzing various golf swings with low delay in order to provide a user with the results of analysis by precisely analyzing a golf swing based on only a movement of the wrist of the user without additional equipment by using the inertial measurement unit (IMU) sensor of a wearable device.

### BACKGROUND

### 1. Technical Field

The present disclosure relates to a system and method for analyzing a golf swing using a wearable device, and more particularly, to a system for analyzing a golf swing which provides a high-efficiency operation recognition algorithm and technical solution capable of analyzing various golf swings with low delay in order to provide a user with the results of analysis by precisely analyzing a golf swing based on only a movement of the wrist of the user without additional equipment by using the inertial measurement unit (IMU) sensor of a wearable device.

### 2. Related Art

Recently, general public's perception of golf has changed due to the expansion of leisure activities and the growth of national income. Golf that was once considered as the exclusive pastime of the wealthy has become a popular sport accessible to people of all ages and genders nationwide due to the expansion of golf infrastructure and widespread adoption of screen golf.

In such a situation, techniques for providing the analysis of golf swings are variously developed and improved. The existing system for analyzing golf swings is provided in various forms, but most of the systems adopt a method of analyzing golf swings by attaching a separate sensor to a golf club or using a high-speed camera and an external sensor. Among the systems, an optics-based system has disadvantages in that an installation cost is high, real-time feedback is difficult, and performance may vary depending on external environments (e.g., lights and camera placement). A simulation-based system has problems in that the system can be used only in a fixed indoor environment, restricting its applicability outdoors. That is, the conventional methods have problems in that equipment installation is inconvenient, costs for equipment installation are high, and real-time feedback is difficult.

A prior art related to the present disclosure includes Korean Patent Application Publication No. 10-2018-0062069, and still has the aforementioned problems.

### SUMMARY

Various embodiments are directed to implementing a system which analyzes the golf swings of a user in real time by using a wearable device and provides immediate feedback while operating in conjunction with a user terminal.

Furthermore, various embodiments are directed to supporting a user to easily evaluate and improve his or her own swings by measuring data relating to swings by using the inertial measurement unit (IMU) sensor of a wearable device and analyzing the measured data in real time.

In an embodiment, a system for analyzing a golf swing includes a wearable device configured to collect inertial measurement unit (IMU) data of a user, a data collection unit configured to receive the IMU data from the wearable device in real time, a signal processor configured to convert the IMU data into continuous data, a swing recognition unit configured to derive whether the user has taken a swing and a current state of the swing by analyzing the converted IMU data, and a swing analysis unit configured to analyze the results of the swing by analyzing the converted IMU data. The wearable device is a device mounted on a wrist of the user. The signal processor, the swing recognition unit, and the swing analysis unit are driven by a cross platform API on which two or more wearable device interfaces have been mounted.

Furthermore, the signal processor includes a noise detection module configured to detect noise included in the IMU data and a noise filtering module configured to filter out the detected noise. The noise filtering module includes a low filter that is used when amplitude of the noise is smaller than a reference value and a high filter that is used when the amplitude of the noise is greater than the reference value. Cubic spline interpolation is used in the high filter.

Furthermore, the swing recognition unit determines whether the user has taken an address based on the size of a gyroscope and the tilt angle of an accelerometer, among the IMU data. When the size of the gyroscope is measured to be a reference value or less and the tilt angle of the accelerometer is within a reference angle range in a direction of gravity, the swing is determined to be in an address state.

In an embodiment, a method of analyzing a golf swing includes an interlocking step of making a system client and a wearable device operate in conjunction with each other, a data transmission step of receiving, by a data collection unit, inertial measurement unit (IMU) from the wearable device in real time, a data processing step of converting, by a signal processor, the IMU data into continuous data, a swing recognition step of deriving, by a swing recognition unit, whether a user has taken a swing and a current state of the swing by analyzing the converted IMU data, and a swing analysis step of analyzing, by a swing analysis unit, the results of the swing by analyzing the converted IMU data. The wearable device is a device mounted on a wrist of the user. The signal processor, the swing recognition unit, and the swing analysis unit are driven by a cross platform API on which two or more wearable device interfaces have been mounted.

The system and method for analyzing a golf swing having the components and steps according to embodiments of the present disclosure have an effect in that the analysis of a swing and feedback thereof can be provided in real time by receiving swing data through a wearable device even without a separate device.

Furthermore, the system and method for analyzing a golf swing has effects in that accurate swing analysis using a high-level signal processing scheme, compatibility with various platforms, a swing pattern, the analysis of the features of each user, and a low-cost and high-efficiency golf swing analysis service can be provided.

### BRIEF DESCRIPTION OF THE DRAWINGS

FIG. 1 is a schematic construction diagram of a system for analyzing a golf swing according to an embodiment of the present disclosure.

FIG. 2 is a detailed construction diagram of an IMU sensor module according to an embodiment of the present disclosure.

FIG. 3 is a diagram illustrating steps of a method of analyzing a golf swing according to an embodiment of the present disclosure.

FIG. 4 is a diagram illustrating a process relating to data transmission according to an embodiment of the present disclosure.

FIG. 5 is a diagram illustrating an embodiment relating to an operation according to an embodiment of the present disclosure.

FIG. 6 is a diagram illustrating an embodiment relating to the data of a gyroscope after processing.

FIG. 7 is a diagram illustrating an embodiment relating to the data of an accelerometer after processing.

FIG. 8 is a diagram illustrating an embodiment relating to the determination of an address state.

FIG. 9 is a diagram illustrating an embodiment relating to the determination of a swing state.

### DETAILED DESCRIPTION

The present disclosure may be changed in various ways and may have various embodiments. Embodiments (or implementation examples) are described in the specification in detail. It is however to be understood that the present disclosure is not intended to be limited to the specific disclosure and that the present disclosure includes all changes, equivalents and substitutions which fall within the spirit and technical scope of the present disclosure.

Terms used in this specification are used to only describe specific embodiments and are not intended to restrict the present disclosure. An expression of the singular number includes an expression of the plural number unless clearly defined otherwise in the context. In this specification, a term, such as “include (or comprise)” or “have”, is intended to designate the presence of a characteristic, a number, a step, an operation, a component, a part or a combination of them described in the specification, and should be understood that it does not exclude the possible existence or addition of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

Terms, such as “a first ~” and “a second ~” described in the specification, are used to merely distinguish between different components, and are not restricted by a fabricated sequence. The names of components may not be the same in the detailed description and claims of the present disclosure.

Embodiments of the present disclosure relate to a system and method for analyzing a golf swing using a wearable device (hereinafter referred to as a “system” and a “method”, respectively), and provide a high-efficiency operation recognition algorithm and technical solution capable of analyzing various golf swings with low delay in order to provide a user with the results of analysis by precisely analyzing a golf swing based on only a movement of the wrist of the user without additional equipment by using the inertial measurement unit (IMU) sensor of a wearable device. Hereinafter, the system and the method are described in detail with reference to the accompanying drawings.

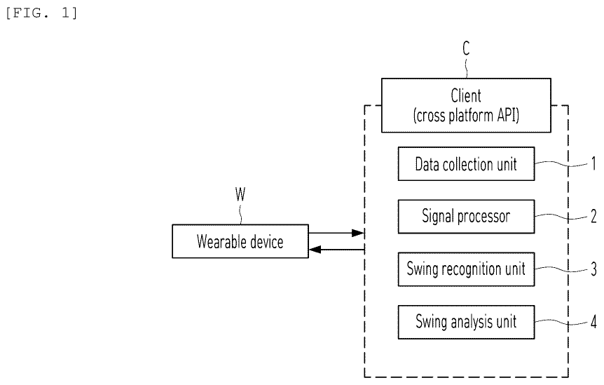

FIG. 1 is a schematic construction diagram of the system. As illustrated in FIG. 1, the system includes a wearable device W and a client C mounted on a user terminal.

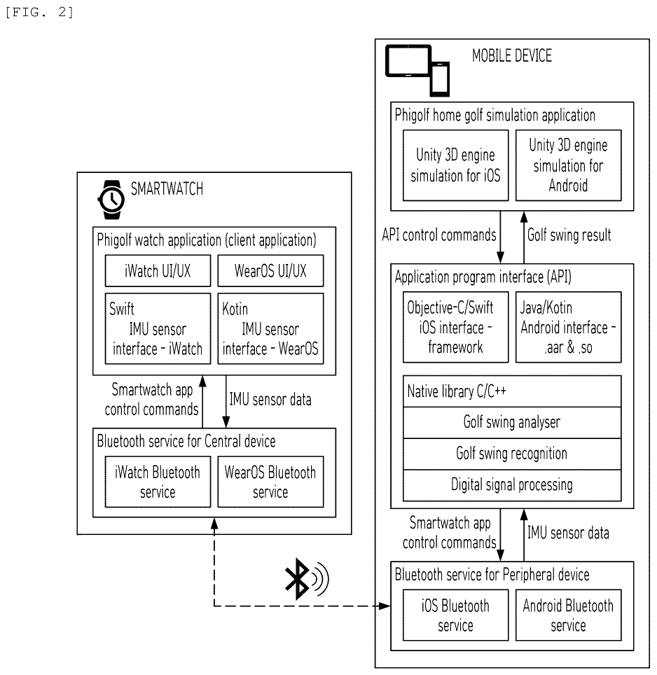

Each component is described in detail. As illustrated in FIG. 2, the wearable device W is a device that is mounted on the body of a user and that collects the swing data of the user. An inertial measurement unit (IMU) sensor module is mounted on the wearable device W in order to collect IMU data related to the swing of a user. Furthermore, it is preferred that the wearable device W is a device mounted on the wrist of a user. In the description of the present disclosure, a smartwatch is described as an example, in consideration of the fact that the most common form among currently commercialized wearable devices is a watch-type device referred to as a smartwatch, and that the arm is the body portion that moves most significantly during a golf swing.

As illustrated in FIG. 2, the IMU sensor module may include a gyroscope and an accelerometer in order to collect the direction, speed, rotation angle, and tempo of a swing by measuring the rotation and angular velocity of the wrist of a user. Furthermore, the IMU sensor module may further include a magnetometer in order to improve accuracy by correcting the direction of the wearable device W under a specific environment.

Referring to FIG. 2, the wearable device W may further include a communication module for communication with the user terminal. Bluetooth, Wi-Fi, NFC, ultra-wideband (UWB), LTE/5G (cellular communication), Zigbee/Z-Wave, and long range (LoRa) may be used in the communication module. It may be preferred that a Bluetooth method is adopted by comprehensively considering real-time data transfer and power efficiency.

The client C is a component that is mounted on the user terminal and that analyzes a swing based on collected data. In the system, the user terminal may include a mobile device represented as a smartphone and a portable computing device represented as a table PC. It is preferred that the user terminal is a mobile device when comprehensively considering a condition on which wireless communication, such as Bluetooth, can be provided, and a distribution rate.

Furthermore, the client C may be driven by a cross platform API on which two or more wearable device interfaces have been mounted. An example of the client C is described with reference to FIG. 2. The client C may have different types of interfaces, such as Objective-C/Swift and Java/Kotin, mounted thereon in order to collect data from a heterogeneous wearable device W and analyze the collected data.

Hereinafter, core components of the system are described in detail. As illustrated in FIGS. 1 and 2, the client C may include a data collection unit 1 that receives inertial measurement unit (IMU) data from the wearable device W in real time, a signal processor 2 that converts the IMU data into continuous data, a swing recognition unit 3 that derives whether a user has taken a swing and the current state of the swing by analyzing the converted IMU data, and a swing analysis unit 4 that analyzes the results of the swing by analyzing the converted IMU data.

The data collection unit 1 is a component that receives IMU data from the wearable device W in real time. The IMU data needs to be collected and transmitted in real time and continuously in the entire process until a swing operation is completed from an address state for a swing. To this end, the Bluetooth pairing method may be advantageous. Furthermore, the client C may transmit a command in order to control the wearable device W to perform a function in addition to data transmission. Accordingly, it is evidently preferred that the wearable device W and the user terminal are capable of bidirectional communication.

Furthermore, as an embodiment relating to the data collection unit 1, the data collection unit 1 may be designed to maintain data sampling of 100 Hz or more by optimizing the transfer rate and to collect swing data when the wearable devices W are worn on both hands of a user by supporting a multi-device connection. Furthermore, the data collection unit 1 may be configured to continuously monitor the strength of a signal and to guarantee connection stability by automatically performing a re-connection when disconnected.

Furthermore, the data collection unit 1 may include a data packet processing module that performs a function for managing data transmitted by the wearable device W in a packet unit and correcting lost data. The data packet processing module may be configured to recover missed data by applying a correction algorithm based on anterior and posterior data patterns when a packet is lost during data transmission and to perform timestamp-based alignment in order to solve a problem in that a packet sequence is changed. Furthermore, the data packet processing module may be configured to optimize the transfer rate and reduce a network load by applying a data compression algorithm and also to maintain data accuracy necessary for real-time analysis.

The data collection unit 1 may further include a synchronization module that functions to align received IMU data and synchronize the data of a gyroscope, an accelerometer, and a magnetometer on the basis of the same time. The synchronization module consistently maintains the sampling rate so that data of 100 Hz or more is regularly collected, and enables more accurate swing analysis through the convergence of the data of multiple sensors (e.g., a gyroscope, an accelerometer, and a magnetometer).

The signal processor 2 is a component that converts IMU data into continuous data. The IMU data is collected and transmitted as discontinuous data every specific time, but proper conversion needs to be performed on the IMU data because continuous data is required for swing analysis. Furthermore, it is preferred that the signal processor 2 further includes a component capable of detecting noise and filtering out the noise because the noise may be included in collected IMU data.

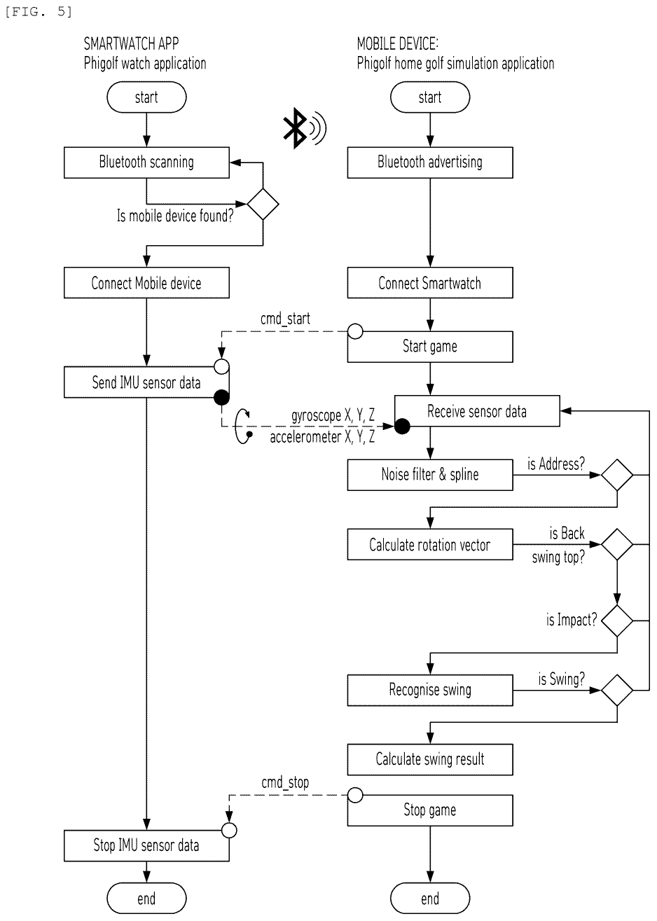

Specifically, as may be seen from FIG. 5, the signal processor 2 may include a noise detection module that detects noise included in IMU data and a noise filtering module that filters out the detected noise.

The noise detection module detects noise included in IMU data. As a detailed embodiment, the noise detection module may recognize noise by measuring the parameters of three adjacent signals and detecting a deviation with a previously received value. A data stream includes a predefined frequency. Accordingly, the noise detection module may detect noise by analyzing angles between three adjacent signals in a time axis and comparing the angles with a measurement range of the sensor. For example, assuming that three adjacent signals are A, O, and B, noise may be detected according to Equation 1.

$$\vec{a} = \vec{OA} , \vec{b} = \vec{OB} ; cos α = \frac{\vec{a} \cdot \vec{b}}{\vert \vec{a} \vert \cdot \vert \vec{b} \vert} ; \qquad ( 1 )$$

$$α = {cos}^{- 1} \frac{\vec{a} \cdot \vec{b}}{\vert \vec{a} \vert \cdot \vert \vec{b} \vert} ;$$

In Equation 1, when α<αₘᵢₙ, it may be determined that spike noise is present.

Furthermore, when the size of each of a vector “a” and a vector “b” is greater than lₘₐₓ, that is, a set maximum value, on the basis of the size of each of the vector “a” and the vector “b”, it may be determined that the size of each of the vector “a” and the vector “b” has reached a maximum or minimum range which may be measured by the sensor or is greater than a measurement limit.

Furthermore, the noise filtering module filter outs detected noise. As a detailed embodiment, the noise filtering module may include a low filter that is used when amplitude of noise is smaller than a reference value use and a high filter that is used when the amplitude of noise is greater than the reference value.

The low filter is a filter using the moving average and uses an average of the three adjacent signals A, O, and B.

Cubic spline interpolation may be used in the high filter. The interpolation function of the cubic spline interpolation that makes smooth swing trajectory by correcting lost data after filtering is effective in correcting a deviation signal when the amplitude of noise is relatively high. In particular, the cubic spline interpolation is adopted because it is useful in linearly constructing a complex function by approximating the complex function when only the value of a signal is known at a specific time by constructing a smooth curve that passes through a series of points. The cubic spline interpolation may be performed according to the following process (hereinafter referred to as a “revision equation”).

a) When n signals (x₁, y₁), (x₂, y₂), . . . , (xₙ, yₙ) are given, a tertiary spline function for each interval is expressed as in Equation 2.

$${S}_{1} ( x ) = {y}_{1} + {b}_{1} ( x - {x}_{1} ) + {{c}_{1} ( x - {x}_{1} )}^{2} + {{d}_{1} ( x - {x}_{1} )}^{3} , x ∈ [ {x}_{1} , {x}_{2} ] \qquad ( 2 )$$

$${S}_{2} ( x ) = {y}_{2} + {b}_{2} ( x - {x}_{2} ) + {{c}_{2} ( x - {x}_{2} )}^{2} + {{d}_{2} ( x - {x}_{2} )}^{3} , x ∈ [ {x}_{2} , {x}_{3} ] ,$$

$$… … … …$$

$${S}_{n - 1} ( x ) = {y}_{n - 1} + {b}_{n - 1} ( x - {x}_{n - 1} ) + {{c}_{n - 1} ( x - {x}_{n - 1} )}^{2} + {{d}_{n - 1} ( x - {x}_{n - 1} )}^{3} ,$$

$$x ∈ [ {x}_{n - 1} , {x}_{n} ]$$

b) According to an interpolation condition, a function satisfies the following requirements.

$${S}_{i} ( {x}_{i} ) = {y}_{i} , i = 1 , … , n - 1 \qquad ( 3 )$$

$${S}_{n - 1} ( {x}_{n} ) = {y}_{n}$$

$${S}_{i} ( {x}_{i + 1} ) = {S}_{i + 1} ( {x}_{i + 1} ) = {y}_{i + 1} , i = 1 , … , n - 2$$

c) In order to obtain the smooth curve, first and second function differentiations need to satisfy the following requirements.

$${S}_{i}^{′} ( {x}_{i + 1} ) = {S}_{i + 1}^{′} ( {x}_{i + 1} ) , i = 1 , … , n - 2 \qquad ( 4 )$$

$${S}_{i}^{″} ( {x}_{i + 1} ) = {S}_{i + 1}^{″} ( {x}_{i + 1} ) , i = 1 , … , n - 2$$

d) Natural spline needs to satisfy the following requirements.

$${S}_{1}^{″} ( {x}_{1} ) = 0 , {S}_{n - 1}^{″} ( {x}_{n} ) = 0 \qquad ( 5 )$$

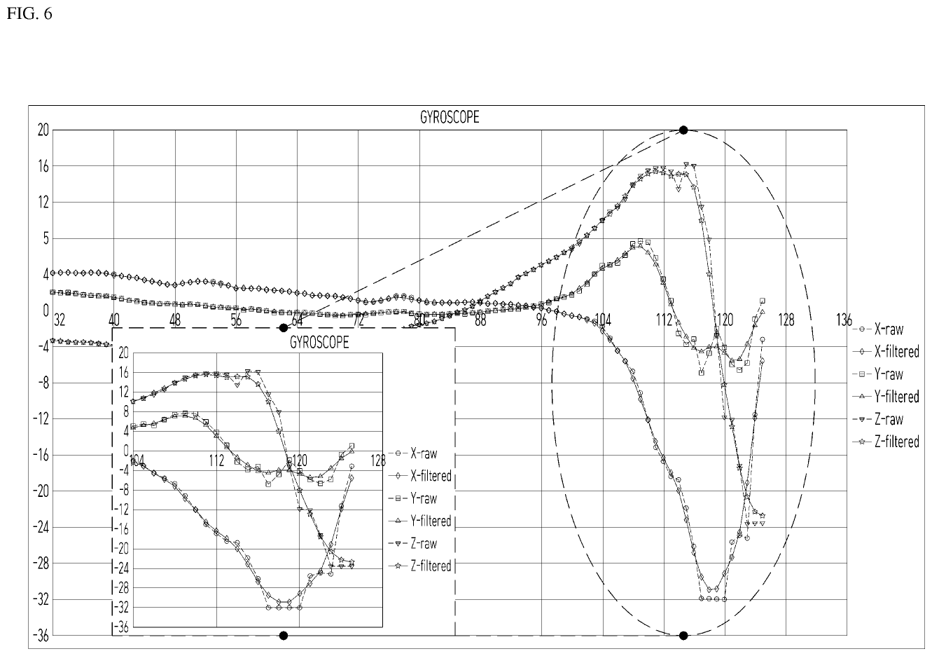

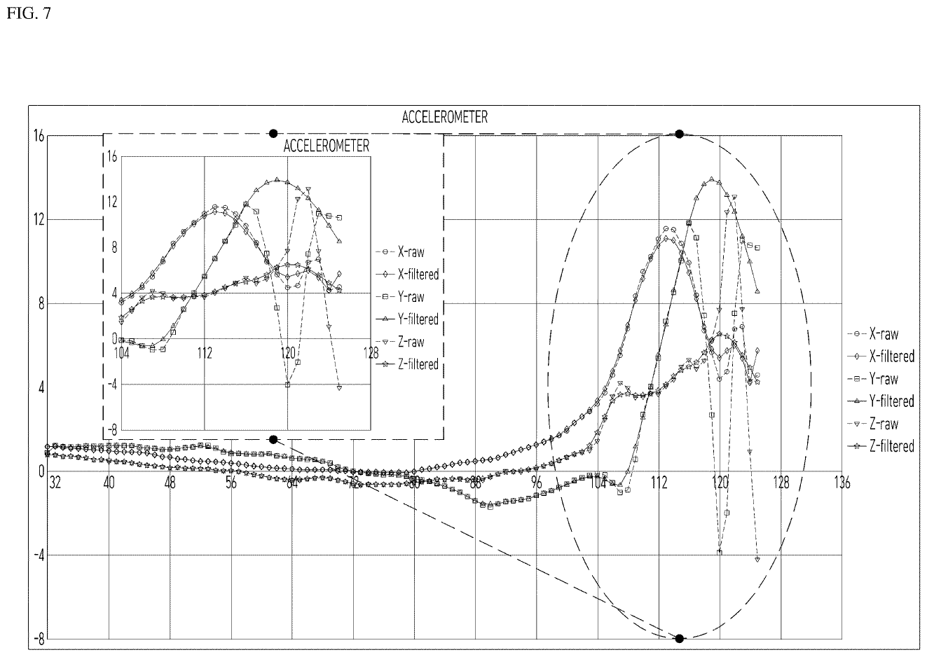

Noise of the gyroscope that is corrected through such spline interpolation, among the IMU data, may be filtered out as illustrated in FIG. 6. Noise of the accelerometer, among the IMU data, may be filtered out as illustrated in FIG. 7.

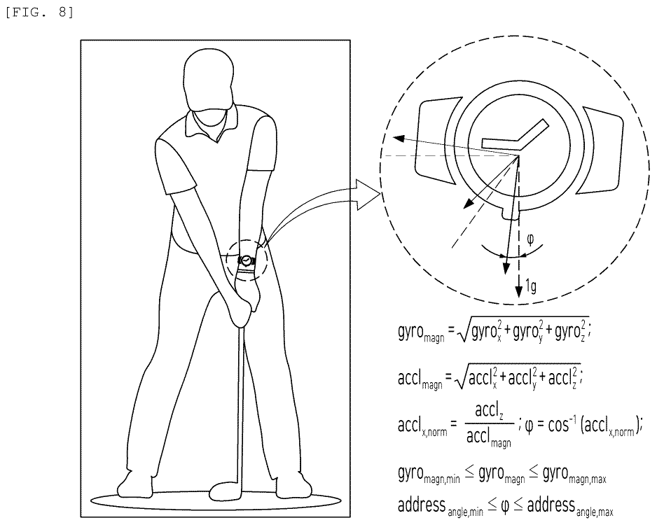

Next, the swing recognition unit 3 derives whether a user has taken a swing and the current state of the swing by analyzing the converted IMU data. A swing can be recognized by reading an address state because an initial step of a swing operation is an address. Specifically, as illustrated in FIG. 8, the swing recognition unit 3 determines whether the user has taken an address based on the size of the gyroscope and the tilt angle of the accelerometer, among the IMU data. In this case, when the size of the gyroscope is measured to be a reference value or less and the tilt angle of the accelerometer is within a reference angle range in the direction of gravity, the swing may be determined to be in the address state. More clearly, a determination of the address state needs to satisfy the following requirements.

a) The wearable device W needs to be fixed or needs to be moved at the very least. That is, when the size of the gyroscope is between a preset minimum value 0 and a preset maximum value (the reference value), one condition on which the address state may be determined is satisfied.

b) The wearable device W needs to be inclined at an angle within a predefined range with respect to a gravity vector. An address location is defined by a condition including the size of the gyroscope and the tilt angle of the accelerometer within a predefined range. That is, when an angle in the direction of gravity is between a preset minimum value and a preset maximum value (reference range), another condition on which the address state may be determined is satisfied. That is, when both the conditions a) and b) are satisfied, the swing is determined to be in the address state.

Thereafter, the swing recognition unit 3 recognizes the current state of the swing. The swing may be conceptualized by a sensor that rotates around a fixed point in a three-dimensional space. The swing may be considered as maintaining an almost constant distance (i.e., from the chest of a user to hands). Accordingly, the swing recognition unit 3 may detect the swing by analyzing the rotation trajectory of the sensor by calculating quaternions. Such a swing recognition algorithm may follow the following procedure (this is described by the revision equation).
1) An Euler angle at an initial location (address location) is converted into the quaternions.
2) A series of quaternions indicative of a rotation movement of the sensor are generated by applying a Madgwick filter to the IMU data.
3) Direction cosine is calculated by using the quaternions, and swing route trajectory is determined.
4) A swing pattern is recognized based on the calculated swing route trajectory.

A common form of the quaternions is as follows.

$$q = {q}_{0} + q = {q}_{0} + {iq}_{1} + {jq}_{2} + {kq}_{3} ; \qquad ( 6 )$$

$${i}^{2} = {j}^{2} = {k}^{2} = ijk = - 1$$

$$ij = k = - ji$$

$$jk = i = - kj$$

$$ki = j = - ik$$

Furthermore, the Euler angle is converted into the quaternions as follows.

$${q}_{0} = cos \frac{ψ}{2} cos \frac{θ}{2} cos \frac{ϕ}{2} + sin \frac{ψ}{2} sin \frac{θ}{2} sin \frac{ϕ}{2} \qquad ( 7 )$$

$${q}_{1} = cos \frac{ψ}{2} cos \frac{θ}{2} sin \frac{ϕ}{2} - sin \frac{ψ}{2} sin \frac{θ}{2} cos \frac{ϕ}{2}$$

$${q}_{2} = cos \frac{ψ}{2} sin \frac{θ}{2} cos \frac{ϕ}{2} + sin \frac{ψ}{2} cos \frac{θ}{2} sin \frac{ϕ}{2}$$

$${q}_{3} = sin \frac{ψ}{2} cos \frac{θ}{2} cos \frac{ϕ}{2} - cos \frac{ψ}{2} sin \frac{θ}{2} sin \frac{ϕ}{2}$$

Furthermore, an equation for rotating the vector based on the quaternions in the three-dimensional space is as follows. In this case, it is assumed that a vector v∈R is pure quaternions v=0+v. That is, the vector is rotated based on given quaternions q=q+q as follows.

$$w = {qvq}^{*} = ( {q}_{0} + q ) ( 0 + v ) ( {q}_{0} - q ) = ( 2 {q}_{0}^{2} - 1 ) v + 2 ( q \cdot v ) q + 2 {q}_{0} ( q \times v ) \qquad ( 8 )$$

$$[ \begin{matrix}\begin{matrix}{w}_{1} \\ {w}_{2}\end{matrix} \\ {w}_{3}\end{matrix} ] = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}\begin{matrix}{v}_{1} \\ {v}_{2}\end{matrix} \\ {v}_{3}\end{matrix} ]$$

$${m}_{11} = 2 {q}_{0}^{2} - 1 + 2 {q}_{1}^{2} ; {m}_{12} = 2 {q}_{1} {q}_{2} - 2 {q}_{0} {q}_{3} ;$$

$${m}_{13} = 2 {q}_{1} {q}_{3} + 2 {q}_{0} {q}_{2}$$

$${m}_{21} = 2 {q}_{1} {q}_{3} + 2 {q}_{0} {q}_{3} ; {m}_{22} = 2 {q}_{0}^{2} - 1 + 2 {q}_{2}^{2} ;$$

$${m}_{23} = 2 {q}_{2} {q}_{3} - 2 {q}_{0} {q}_{1}$$

$${m}_{31} = 2 {q}_{1} {q}_{3} - 2 {q}_{0} {q}_{2} ; {m}_{32} = 2 {q}_{2} {q}_{3} + 2 {q}_{0} {q}_{1} ;$$

$${m}_{33} = 2 {q}_{0}^{2} - 1 + 2 {q}_{3}^{2}$$

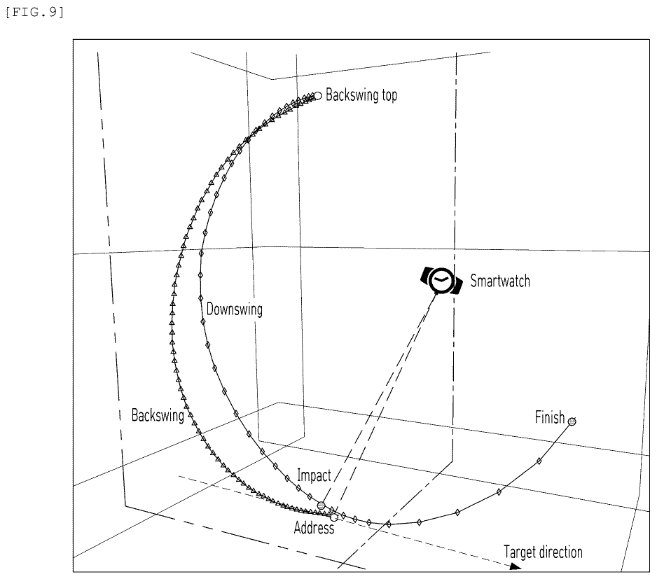

According to such a process, as illustrated in FIG. 9, a current swing state and swing trajectory may be recognized. It may be determined whether the swing is currently in the address state, a backswing state, a downswing state, an impact state, a follow-through state, or a finish state.

Next, the swing analysis unit 4 analyzes the results of the swing by analyzing the converted IMU data. As a detailed embodiment, the results of the analysis of the swings may be analyzed as follows (described by the revision equation).
1) A club head speed: calculated as the size of angular velocity
2) A face angle: calculated based on a difference between the angles of an address location and an impact location in the axes of rotation vectors x, y, and z on a horizontal plane
3) An attack angle: calculated based on a difference between the angles of the address location and the impact location in the axes of the rotation vectors x, y, and z on a vertical plane
4) A tempo: calculated as the ratio of a backswing time and a downswing time

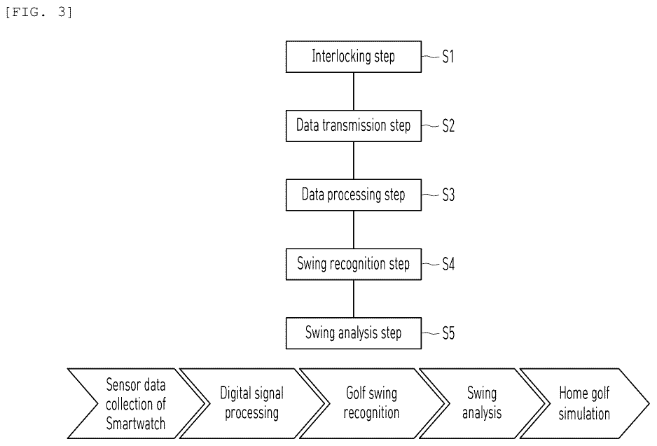

Hereinafter, a method of analyzing a golf swing according to an embodiment of the present disclosure is described with reference to the accompanying drawings. As illustrated in FIG. 3, the method may include an interlocking step S1, a data transmission step S2, a data processing step S3, a swing recognition step S4, and a swing analysis step S5. Hereinafter, in order to avoid a redundant description, the method is described with reference to the description of the system.

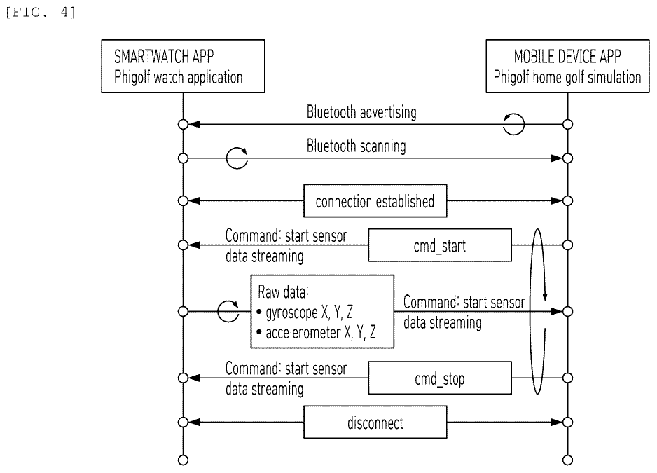

The interlocking step S1 is a step of the client C and the wearable device W operating in conjunction with each other. The wearable device W and the user terminal exchange IMU data and commands in real time. FIG. 4 illustrates the interlocking step S1.

Next, the data transmission step S2 is a step of transmitting IMU data collected by the wearable device W to the user terminal. As illustrated in FIG. 4, the user terminal transmits sensor driving and data streaming commands to the wearable device W. In response thereto, the wearable device W transmits the IMU data to the user terminal. Thereafter, when the user terminal transmits a sensor driving stop command, the transmission of the IMU data is stopped.

Next, the data processing step is a step of converting, by the signal processor 2, the IMU data into continuous data, and is a step of detecting noise, filtering out the detected noise, and converting the IMU data into the continuous data, that is, a data function, by correcting a data loss after the filtering.

Next, the swing recognition step S4 is a step of driving, by the swing recognition unit 3, whether a user has taken a swing and the current state of the swing by analyzing the converted IMU data. In the swing recognition step S4, whether a user has taken an address is detected based on the size of the gyroscope and the tilt angle of the accelerometer. When the size of the gyroscope is a reference value or less and the tilt angle of the accelerometer is within a reference angle range in the direction of gravity, the swing is determined to be in the “address state”. The steps (i.e., an address, a backswing, a downswing, an impact, follow-through, and a finish) of the swing are separately recognized through conversion into quaternions and pattern analysis.

Next, the swing analysis step S5 is a step of analyzing, by the swing analysis unit 4, the results of the swing by analyzing the converted IMU data. As described above, in the swing analysis step S5, a club head speed, a face angle, an attack angle, and a tempo are analyzed.

Next, the method may further include a feedback provision step. In the feedback provision step, analyzed results may be provided as visual or voice feedback through a user interface (UI). As another embodiment, swing trajectory may be visualized as 3-D animation a so that a user can intuitively understand a swing. As still another embodiment, the swing of a user may be evaluated by being compared with a standard swing, and guidance to a portion that needs to be improved may be provided. As still another embodiment, a personalized swing correction guide may be provided by applying an AI-based machine learning model.

The present disclosure described above with reference to the accompanying drawings may be modified and changed in various ways by those skilled in the art. Such modifications and changes that are not limited through the claims should be interpreted as being included in the scope of a right of the present disclosure.

[Description of reference numerals]

| | |
|---|---|
| W: wearable device | C: client |
| 1: data collection unit | 2: signal processor |
| 3: swing recognition unit | 4: swing analysis unit |

What is claimed is:

1. A system for analyzing a golf swing, comprising:
a wearable device configured to collect inertial measurement unit (IMU) data of a user;
a data collection unit configured to receive the IMU data from the wearable device in real time;
a signal processor configured to convert the IMU data into continuous data;
a swing recognition unit configured to derive whether the user has taken a swing and a current state of the swing by analyzing the converted IMU data; and
a swing analysis unit configured to analyze results of the swing by analyzing the converted IMU data,
wherein the wearable device is a device mounted on a wrist of the user, and
the signal processor, the swing recognition unit, and the swing analysis unit are driven by a cross platform API on which two or more wearable device interfaces have been mounted.

2. The system for analyzing a golf swing of claim 1, wherein:
the signal processor comprises a noise detection module configured to detect noise included in the IMU data and a noise filtering module configured to filter out the detected noise,
the noise filtering module comprises a low filter that is used when amplitude of the noise is smaller than a reference value use and a high filter that is used when the amplitude of the noise is greater than the reference value use, and
cubic spline interpolation is used in the high filter.

3. The system for analyzing a golf swing of claim 1, wherein:
the swing recognition unit determines whether the user has taken an address based on a size of a gyroscope and a tilt angle of an accelerometer, among the IMU data, and
when the size of the gyroscope is measured to be a reference value or less and the tilt angle of the accelerometer is within a reference angle range in a direction of gravity, the swing is determined to be in an address state.

4. A method of analyzing a golf swing, comprising:
an interlocking step of making a system client and a wearable device operate in conjunction with each other;
a data transmission step of receiving, by a data collection unit, inertial measurement unit (IMU) from the wearable device in real time;
a data processing step of converting, by a signal processor, the IMU data into continuous data;
a swing recognition step of deriving, by a swing recognition unit, whether a user has taken a swing and a current state of the swing by analyzing the converted IMU data; and
a swing analysis step of analyzing, by a swing analysis unit, results of the swing by analyzing the converted IMU data,
wherein the wearable device is a device mounted on a wrist of the user, and
the signal processor, the swing recognition unit, and the swing analysis unit are driven by a cross platform API on which two or more wearable device interfaces have been mounted.
